(19) United States
(12) Patent Application Publication
(10) Pub. No.: US 2026/0323370 A1
(43) Pub. Date: Oct. 15, 2026

(54) 5G MUP QoS Flow Support Using Compressed SID Prefix or Value

(71) Applicant: Ciena Corporation, Hanover, MD (US)

(72) Inventors: Jahanzeb Baqai, Livermore, CA (US); Muthurajah Sivabalan, Kanata (CA); Tao Wang, Ottawa (CA)

(73) Assignee: Ciena Corporation, Hanover, MD (US)

(21) Appl. No.: 19/175,190

(22) Filed: Apr. 10, 2025

(51) Int. Cl. H04W 28/02; H04L 5/00

(52) U.S. Cl. CPC H04W 28/0268; H04L 5/0048; H04W 28/0273

(57) ABSTRACT

An SRv6 Segment Routing Gateway (SRGW) method supports Quality of Service (QoS) flows for 5G Mobile User Plane (MUP) deployments using compressed Segment Identifiers (SIDs). QoS flow information extracted from packets originating at mobile network nodes is embedded directly into compressed SIDs, specifically using portions of either the common prefix or the SID value field. Two embodiments are presented: embedding QoS information within the common prefix or dedicating SID fields as QoS-specific identifiers. After embedding, packets traverse the SRv6 network, maintaining QoS information end-to-end. The SRGW retrieves QoS information from the compressed SIDs upon return and re-encapsulates this information into packet headers for downstream mobile nodes. This approach reduces packet overhead, enhances scalability, optimizes resource use, and complies with existing standards, significantly improving network performance in 5G SRv6 deployments.

### FIELD OF THE DISCLOSURE

The present disclosure relates generally to networking. More particularly, the present disclosure relates to systems and methods for a 5G mobile user plane (MUP) Quality of Service (QoS) flow support using compressed Segment Identifier (SID) prefix or value.

### BACKGROUND OF THE DISCLOSURE

RFC 9433, Segment Routing over IPv6 for the Mobile User Plane, July 2023, the contents of which are incorporated by reference, defines the network application of Segment Routing over IPv6 (SRv6) for the Mobile User Plane (MUP), facilitating simplified network architecture. The Mobile User Plane refers to the data plane functionality in mobile networks responsible for transporting user data packets between mobile devices and external networks (e.g., the Internet). MUP specifically addresses packet routing, QoS management, and encapsulation/de-encapsulation processes across mobile network components. According to RFC 9433, particularly for 5G MUP deployments, a Protocol Data Unit (PDU) session header stores per QoS flow information within the General Packet Radio Service (GPRS) Tunneling Protocol User Plane (GTP-U) header, carried over IP tunnels in user traffic. This header, referred to as the Args.Mob.Session header, specifically contains QoS flow details such as a 6-bit QoS Flow Identifier (QFI), a 1-bit Reflective QoS Indication (RQI), and a PDU session ID. In uplink scenarios where traffic originates from a gNodeB passing through an SRv6 gateway (SRGW), the User Plane Function (UPF) must preserve QoS flow information following the GTP-U decapsulation process in the forwarding plane. Conversely, for downlink traffic, QoS flow information is mapped back from the SRv6 domain into the GTP-U PDU extension header towards the gNodeB during the encapsulation process.

### BRIEF SUMMARY OF THE DISCLOSURE

RFC 9433 explicitly defines how to manage the preservation and restoration of QoS flow information using uncompressed SIDs, specifically utilizing the argument field within the last SID to retain such data. However, this method is not applicable to compressed SIDs, as the argument field does not exist in the compressed SID format, thus leaving the behavior for QoS flow information handling in compressed SIDs undefined. There is no known solution implemented for handling QoS flow information with compressed SIDs within 5G MUP networks. Current deployments of SRv6 for the MUP exclusively utilize uncompressed SIDs. In scenarios involving compressed SIDs, QoS information needs to be accommodated within the limited 24-bit common prefix field of the last SID, rather than the regular 32-bit field used in uncompressed SID deployments. Compressed SIDs offer significant advantages over traditional uncompressed SIDs, primarily due to their efficiency in packet header processing and scalability. Because compressed SIDs occupy fewer bits, network packet overhead is substantially reduced, leading to more efficient bandwidth utilization and improved packet forwarding performance. This compression directly translates into higher scalability, enabling networks to accommodate a greater number of routes and services without exhausting routing table resources, which is particularly beneficial in large-scale 5G deployments.

Supporting SRv6 for MUP using compressed SIDs is crucial because mobile networks, especially with the rapid growth of 5G traffic, increasingly demand highly efficient packet processing and optimal resource utilization. The shift towards compressed SIDs aligns with the industry's move towards streamlined, highly scalable network architectures. Without compressed SID support, operators face limitations in scalability, resource management, and operational efficiency. Therefore, enabling SRv6 with compressed SIDs for MUP ensures networks can sustainably handle growing traffic demands, maintain robust QoS management, and deliver optimized user-plane performance.

The disclosed embodiments relate to a method implemented by a Segment Routing Gateway (SRGW) to support Quality of Service (QoS) flows within a Segment Routing over IPv6 (SRv6) mobile user plane (MUP) network utilizing compressed Segment Identifiers (SIDs). The method includes receiving a first packet containing QoS flow information from a mobile network node, extracting the QoS flow information, embedding this information directly into a compressed SID—such as within a common prefix field, SID value field, or padding field—and subsequently forwarding the packet across the SRv6 network with the QoS-embedded compressed SID. The SRGW may further process return packets by retrieving QoS flow information embedded in compressed SIDs and re-embedding it into encapsulation headers for forwarding toward mobile nodes.

QoS flow information may specifically be embedded in a General Packet Radio Service (GPRS) Tunneling Protocol User Plane (GTP-U) extension header, with extraction including QoS Flow Identifier (QFI) and Reflective QoS Indication (RQI). Embedding mechanisms include repurposing portions of common prefix fields, particularly the least significant 8 bits, potentially including reserved bits for QoS expansion. Alternatively, a 16-bit SID value field of a micro-SID (uSID) can be partitioned into separate portions for SID values and QoS information, or an entire SID value field can be dedicated to uniquely represent QoS flow parameters, thus optimizing resource consumption and enhancing tunnel scalability. QoS information may also be stored in padding bits within a 128-bit generic SID (GSID) container immediately following the SID value.

Processing the dedicated QoS SID directly facilitates explicit QoS handling by network nodes. QoS information configuration can leverage control-plane signaling received via Border Gateway Protocol (BGP) 3GPP 5G Network Layer Reachability Information (NLRI). Notably, intermediate SRv6 nodes remain transparent to the QoS flow information, which is specifically processed only at the SRGW and egress nodes.

The disclosure also encompasses a SRGW configured with circuitry for implementing the described QoS embedding and forwarding methods. Additionally, a non-transitory computer-readable medium storing instructions executable by a SRGW to carry out these QoS flow embedding and forwarding methods is provided.

### BRIEF DESCRIPTION OF THE DRAWINGS

The present disclosure is illustrated and described with reference to the accompanying drawings. Unless otherwise specified, the drawings are not necessarily drawn to scale, and certain features or components may be enlarged, exaggerated, or omitted for clarity. Like reference numerals are used throughout to denote like components or steps, as appropriate.

FIG. 1 illustrates a high-level overview of an integrated 5G MUP network architecture in a network, emphasizing the handling of data traffic through a Segment Routing Gateway (SRGW).

FIG. 2 illustrates two examples of uncompressed SID formats.

FIG. 3 illustrates the structure of an Args.Mob.Session header.

FIG. 4 illustrates an example of a modified uncompressed 64-bit classic SID format.

FIG. 5 illustrates various formats of compressed SIDs utilized in SRv6 technology, specifically highlighting two primary compressed SID categories: micro SIDs (uSID) and generic SIDs (GSID).

FIG. 6 illustrates two examples of modified uSID formats showing use of the common prefix field.

FIG. 7 illustrates two alternative embodiments for embedding QoS flow information within uSID formats to facilitate end-to-end QoS enforcement in 5G networks employing SRv6.

FIG. 8 illustrates alternative embodiments of embedding QoS flow information within compressed Generic Segment Identifiers (GSIDs).

FIG. 9 illustrates a flowchart of a process, performed by a Segment Routing Gateway (SRGW), for supporting Quality of Service (QoS) flows in a Segment Routing over IPv6 (SRv6) mobile user plane (MUP) network using compressed Segment Identifiers (SIDs)

FIG. 10 illustrates a block diagram of a router.

### DETAILED DESCRIPTION OF THE DISCLOSURE

To support end-to-end QoS SRv6 networks, especially for MUP deployments as specified in RFC 9433, it is essential to preserve QoS flow information within compressed SIDs. Previously, maintaining QoS flow data required the use of uncompressed SIDs, specifically leveraging the Argument field within the SID structure. However, given the industry's shift toward more scalable, efficient packet processing architectures, compressed SIDs such as micro-SIDs (uSIDs) are now preferable. Compressed SIDs significantly reduce overhead and improve routing scalability, thus enhancing network resource efficiency and supporting a greater number of concurrent flows.

Various approaches are introduced herein to enable QoS flow preservation using compressed SID formats:
(1) Utilizing the Compressed SID Common Prefix Field,
(2) Repurposing the SID0 Field in uSID; and (
3) Utilizing padding bits of a GSID.

Compressed SIDs inherently include a prefix field used primarily for addressing and routing purposes. Under the first approach, a portion of this prefix field—e.g. the 8 least significant bits—is repurposed to carry essential QoS flow information (e.g., QoS Flow Identifier [QFI]) required for 5G MUP. This utilization allows compressed SIDs to replace traditional uncompressed SID formats, maintaining QoS characteristics without requiring additional headers or fields, thereby optimizing packet overhead and processing efficiency. It provides a practical method to integrate QoS support directly within the existing compressed SID architecture.

Alternatively, compressed SID formats such as uSID contain a specific field known as SID0, traditionally employed to uniquely identify segments within a network. In this second approach, QoS flow information is embedded either partially or entirely within this SID0 field. In a partial embedding scenario, the least significant bits of the SID0 field can store the QoS flow information similarly to the prefix-based solution. In a more extensive scenario, the entire SID0 field is designated as a specialized "QoS SID," explicitly encoded to convey QoS parameters. This dedicated QoS SID could then be processed directly as a SID by network nodes, facilitating explicit QoS handling along the network path and potentially simplifying packet classification and forwarding decisions. The dedicated QoS SID can represent, and be processed as, instructions pertaining to QoS handling

The above approaches represent novel applications of compressed SID fields, transitioning away from dependence on uncompressed SID Argument fields. Crucially, these solutions enable the use of compressed SIDs within existing and emerging 5G network infrastructures, thereby providing the scalability, efficiency, and QoS support needed to handle rapidly increasing mobile data traffic. To realize either approach, the control plane plays an active role. Specifically, the control plane is responsible for copying the QFI flow information into the compressed SID structures (e.g., common prefix or SID0) during Segment Routing tunnel configuration. This copying may occur through the Border Gateway Protocol (BGP) employing 3GPP 5G Network Layer Reachability Information (NLRI). For tunnel SID configuration at the egress Provider Edge (PE), the control plane may ensure that QoS flow details are correctly embedded into SIDs, thereby preserving QoS integrity across the SRv6 MUP network.

### Segment Routing

Segment Routing (SR) is a network routing technique that simplifies traffic management by encoding the path information directly into packet headers. Unlike traditional routing, which relies heavily on maintaining detailed per-flow state information at intermediate routers, Segment Routing enables source-driven path control using predefined segments. Each segment is identified by a unique Segment Identifier (SID), which instructs network nodes on how to forward packets. SIDs represent network functions or topological paths, such as forwarding through specific routers, interfaces, or services. There are different SID formats, including uncompressed (standard-sized, typically 128 bits in IPv6) and compressed versions (shorter, optimized for efficiency), each suited for particular network scenarios. Compressed SIDs, such as micro-SIDs (uSIDs), reduce overhead and enable higher scalability, making them especially advantageous in large-scale deployments like 5G mobile networks.

In SRv6 technology, SIDs can be categorized into two primary types: uncompressed (also referred to as "classic") and compressed (including micro-SIDs or uSIDs, and generic SIDs or GSIDs). Each category includes various SID formats distinguished by their differing bit-length allocations for prefixes, functions, arguments, and padding, facilitating diverse network routing requirements and levels of scalability.

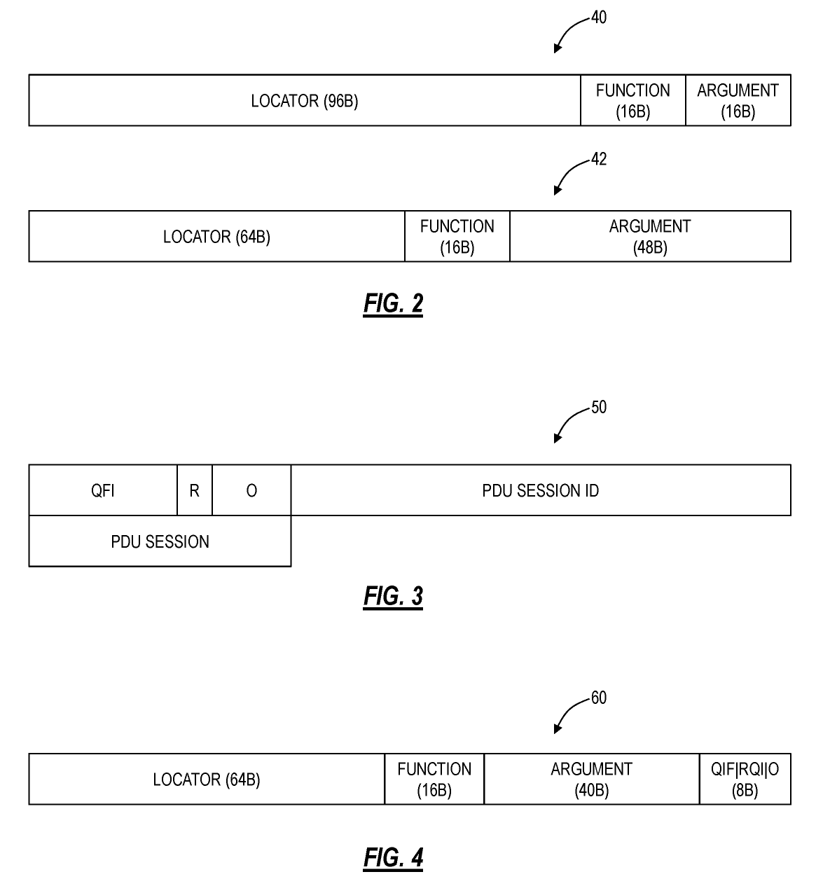

The following are examples of uncompressed SID Formats:
(1) Classic SID with 96-bit Locator: This format includes a 96-bit locator portion that identifies network topology, a 16-bit function specifying the network function or action to execute, and a 16-bit argument field used to carry additional contextual information, such as QoS details. See, e.g., SID 40 of FIG. 2.
(2) Classic SID with 64-bit Locator: In this variant, the locator portion is reduced to 64 bits. It maintains a 16-bit function field, while significantly expanding the argument field to 48 bits, thus accommodating more detailed contextual or QoS-related information. See, e.g., SID 42 of FIG. 2.
(3) Raw 128-bit SID: This SID format uses the entire 128-bit IPv6 address without internal partitioning into locator, function, or argument fields, providing complete flexibility but requiring explicit interpretation by network nodes.

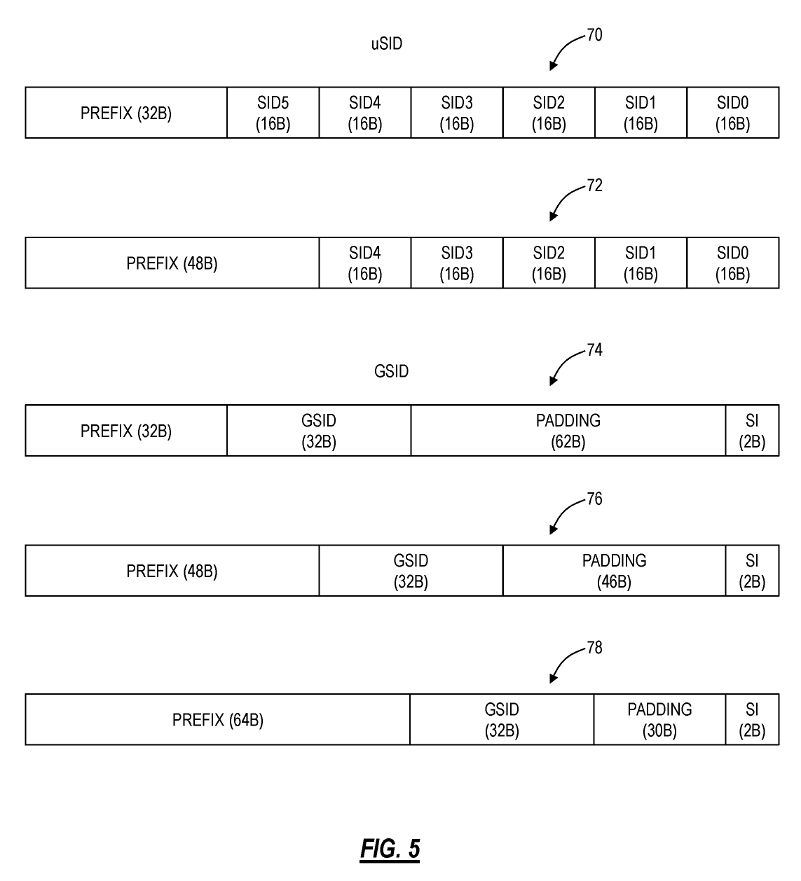

Compressed SIDs are optimized to reduce header overhead, enhancing scalability and efficiency, especially suited for large-scale networks like those deployed for 5G. The following are examples of compressed SID Formats:
(1) Micro SID (uSID) with 32-bit Common Prefix: Consists of a shared 32-bit prefix that identifies a network segment or routing domain, combined with compact 16-bit SID value(s) specifying node-specific actions or paths within the domain. See, e.g., SID 70 of FIG. 5.
(2) Micro SID (uSID) with 48-bit Common Prefix: Similar to the 32-bit micro SID but allocates a longer 48-bit prefix, providing greater addressing flexibility for larger routing domains, while still retaining the compact 16-bit SID value(s) for efficient forwarding. See, e.g., SID 72 of FIG. 5.
(3) Generic SID (GSID) with 32-bit Prefix: This format features a 32-bit common prefix, a 32-bit SID value that explicitly defines segments or node-specific instructions, 62 bits of padding to maintain alignment, and a 2-bit Segment Identifier (SI) indicator to facilitate parsing and routing decisions. See, e.g., SID 74 of FIG. 5.
(4) Generic SID (GSID) with 48-bit Prefix: Uses a larger 48-bit prefix, accompanied by a 32-bit SID, 46-bit padding, and a 2-bit SI indicator. This expanded prefix enables addressing in more extensive networks while preserving efficient segment identification. See, e.g., SID 76 of FIG. 5.
(5) Generic SID (GSID) with 64-bit Prefix: Offers the largest prefix at 64 bits, suitable for extremely large-scale or hierarchical routing deployments, combined with a 32-bit SID, 30 bits of padding, and the standard 2-bit SI indicator to assist with segment processing. See, e.g., SID 78 of FIG. 5.

Each SID format provides distinct trade-offs between addressing scope, flexibility in carrying additional data, scalability, and header efficiency, enabling network operators to select the appropriate structure according to their operational and performance requirements.

### Mup

The MUP refers to the functional layer within mobile networks responsible for transporting and forwarding actual user data packets (e.g., internet traffic, video streaming, messaging) between mobile devices and external data networks. It encompasses packet encapsulation, decapsulation, routing, and QoS management across network nodes such as base stations (e.g., gNodeB in 5G networks), User Plane Functions (UPF), and gateways. The efficiency and scalability of the user plane directly impact overall network performance, latency, and quality of user experience.

RFC 9433 defines the application of SRv6 technology for the Mobile User Plane, establishing a simplified network architecture. While RFC 9433 explicitly defines how QoS flow information preservation and restoration occur for uncompressed Segment Identifiers (SIDs)—by utilizing the argument field in the last SID—it does not define behavior for compressed SIDs, due to differences in SID format and available size. Specifically, compressed SIDs do not have an argument field, leaving no approach to preserve QoS flow information.

This disclosure defines a generic approach to storing QoS flow information within SRv6 MUP packets in 5G network deployments by utilizing compressed SIDs. Specifically, the disclosure provides several flexible options. One option involves embedding QoS flow information directly within the common prefix field of a compressed SID. One option involves assigning a dedicated compressed SID value for each QoS flow. Another includes using padding bits such as in a GSID. These options provide for end-to-end QoS flow enforcement, allowing efficient scalability and optimized network performance for 5G MUP deployments.

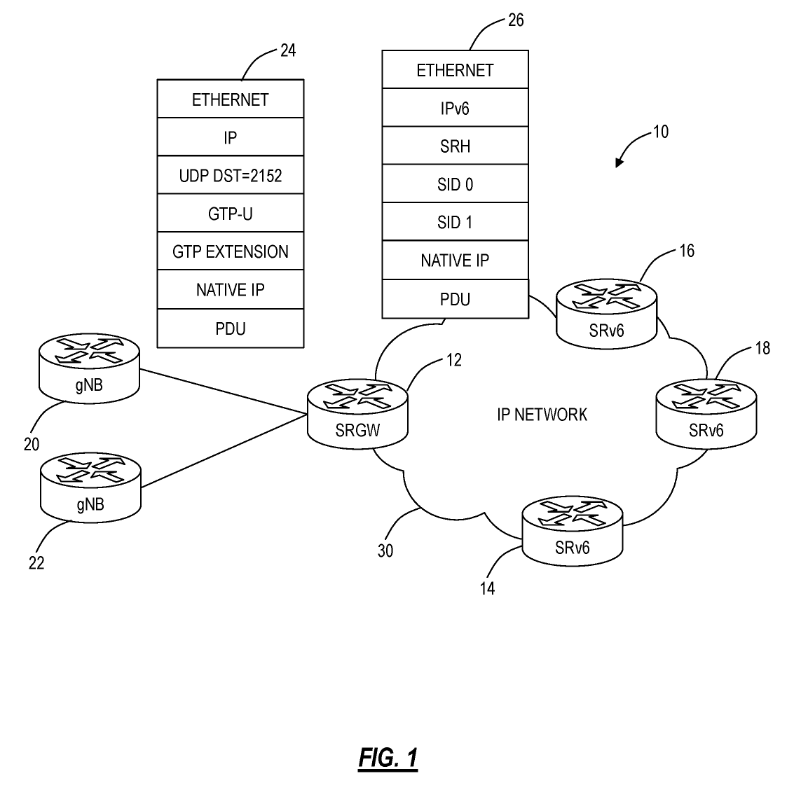

FIG. 1 illustrates a high-level overview of an integrated 5G MUP network architecture in a network 10, emphasizing the handling of data traffic through a Segment Routing Gateway (SRGW) 12. Specifically, FIG. 1 highlights how data packets are formatted and encapsulated differently before and after passing through the SRGW 12, clearly demonstrating the transformation required to integrate SRv6 technology within the mobile user plane context. The network 10 includes the SRGW 12 and additional SRv6 routers 14, 16, 18, and the SRGW 12 connects to two gNodeBs 20, 22 (i.e., 5G base stations). Those skilled in the art will appreciate the network 10 is merely presented for illustration and various other embodiments are contemplated.

Data packets originating from 5G base stations (gNodeBs 20, 22) are depicted with a packet format typically used in mobile networks. Each packet 24 initially includes an Ethernet header, IP header, User Datagram Protocol (UDP) header (with destination port 2152, indicating GTP-U encapsulation), a GTP-U header, and optionally a GTP extension header followed by the native IP payload containing the user Protocol Data Unit (PDU). Upon reaching the SRGW 12, packets undergo encapsulation changes suitable for transmission across an SRv6-enabled IP network 30. After the SRGW 12, as depicted in a packet 26 representation, the original headers are replaced with a simplified SRv6 packet structure. This new packet structure includes an Ethernet header, IPv6 header, Segment Routing Header (SRH), and compressed SIDs such as SID 0 and SID 1, followed by the original native IP payload (PDU).

The SRGW 12 thus functions as a critical translation and encapsulation point within the architecture, adapting traditional mobile data packets into SRv6-compatible formats. The resulting SRv6 packets are then efficiently routed across the IP network 30, represented in the diagram by interconnected SRv6-enabled routers. By clearly distinguishing the before-and-after states of packet encapsulation, FIG. 1 underscores the central role of the SRGW 12 in enabling efficient, scalable, and simplified data forwarding within an integrated SRv6-based 5G MUP network. FIG. 1 intentionally focuses on the User Plane Function (UPF) component, particularly the forwarding aspects of data traffic through the SRGW. Control-plane elements, such as the GTP controllers or signaling mechanisms, are omitted from this visualization to emphasize clarity regarding packet transformation and forwarding behavior in the user plane.

### Uncompressed SID MUP

Before describing the approach for compressed SIDs, it is important to understand the defined behavior for uncompressed SID usage in MUP contexts, specifically for flow information identification as defined in relevant standards. FIG. 2 illustrates two examples of uncompressed SID formats 40, 42. These uncompressed SID formats 40, 42 are specified in RFC 8986, Segment Routing over IPv6 (SRv6) Network Programming, February 2021, the contents of which are incorporated by reference.

In the first depicted format 40, the classic uncompressed SID includes a total length of 128 bits, partitioned into three distinct fields: a 96-bit Locator, a 16-bit Function, and a 16-bit Argument. The Locator field primarily defines the routing prefix or network segment, determining packet routing within the IPv6 network. The Function field explicitly specifies a particular network action or instruction to be executed at the identified SID endpoint. Lastly, the 16-bit Argument field carries additional context-specific information, including QoS flow identifiers or other relevant data required by the network functions.

The second format 42 also represents a 128-bit classic uncompressed SID but with an alternate partitioning scheme. In this variant, the Locator field is shortened to 64 bits, still serving to define network routing paths. The Function field remains at 16 bits, consistently specifying the intended network action. However, this variant significantly increases the Argument field to 48 bits, providing greater flexibility and expanded capability to carry richer, more extensive information, including detailed QoS flow information necessary for end-to-end traffic management and user experience enhancements.

These uncompressed SID formats, with their clearly defined locator, function, and argument components, establish a baseline understanding necessary for appreciating the innovations introduced by compressed SID formats discussed later in this disclosure. FIG. 2 underscores how uncompressed SID structures facilitate explicit flow identification and traffic management capabilities, though at the cost of additional packet overhead compared to compressed alternatives.

FIG. 3 illustrates the structure of an Args.Mob.Session header 50, which is defined as a GTP-U 5G mobile extension header according to RFC 9433. This header 50 is specifically designed to carry QoS flow information within the mobile user plane, ensuring consistent QoS enforcement across network elements. The Args.Mob.Session header 50 includes several clearly defined fields. First, a 6-bit QoS Flow Identifier (QFI) field uniquely identifies the QoS characteristics required by the user data flow, thus enabling the network to manage traffic priorities effectively. Next, a 1-bit Reflective QoS indication (R) field indicates whether reflective QoS should be applied. Following this is a reserved bit (set to zero), ensuring correct field alignment. Finally, the header contains a PDU Session ID, which identifies the Protocol Data Unit session associated with the user traffic, ensuring proper packet routing and session management across network functions.

In operation, when uplink traffic arrives from the gNodeB 20, 22 at the SRGW 12, the UPF extracts QoS-related information (specifically the QFI and reflective QoS indication) from this Args.Mob.Session header 50 during the GTP-U decapsulation process. The UPF then encapsulates this extracted QoS flow information into the argument field of an uncompressed SID before forwarding the packet into the SRv6 network. This approach maintains the integrity and continuity of QoS flow information as data traverses different segments of the 5G mobile network, thereby enabling precise end-to-end QoS enforcement as specified by RFC 9433.

FIG. 4 illustrates an example of a modified uncompressed 64-bit classic SID format 60 specifically adapted to carry QoS information for Differentiated Services Code Point (DSCP) remarking in an outer IPv6 tunnel header. This adaptation is intended to ensure consistent QoS treatment throughout the network path in 5G SRv6 deployments. The depicted SID structure consists of four clearly defined fields:
(1) Locator (64 bits): This field identifies the network segment or specific routing domain, directing the packet along its intended path within the IPv6-based segment routing network.
(2) Function (16 bits): The function field specifies the network action or processing instructions to be performed at the endpoint associated with the SID.
(3) Argument (40 bits): The argument field carries context-specific data, facilitating detailed instructions or additional parameters relevant to packet processing and forwarding.
(4) QoS Information Field (8 bits): The newly introduced QoS information field explicitly stores QoS-related data, such as the QFI and Reflective QoS Indication (RQI), along with reserved bits for alignment. This dedicated QoS field provides a practical mechanism to convey QoS parameters directly within the SID, enabling seamless integration of QoS management into IPv6 headers.

In practice, the QoS information stored within this dedicated 8-bit field can directly inform DSCP remarking operations within the outer IPv6 tunnel header. This approach allows network nodes to prioritize and handle packets according to their QoS requirements without needing additional encapsulation or complex processing. As a result, end-to-end QoS enforcement is effectively maintained across network segments, enhancing the quality of experience for end-users within a 5G mobile user plane deployment utilizing SRv6.

For downlink traffic within a 5G MUP utilizing uncompressed SIDs, the UPF performs the reverse operation to that conducted in the uplink direction. Specifically, the QoS flow information previously stored in the SID's argument field is extracted and reinserted into the GTP-U PDU extension header. This step occurs during the encapsulation process as packets exit the SRv6 domain and enter the traditional GTP-U/IP-based segment of the mobile network toward components such as gNodeBs. By restoring the QoS flow information into the GTP-U PDU extension header, the UPF ensures consistent end-to-end QoS enforcement across the mobile network path. This behavior aligns with RFC 9433 guidelines for uncompressed SIDs, thereby preserving packet flow integrity, QoS characteristics, and enhancing the overall user experience in the 5G MUP environment.

### Compressed SIDs

Again, the present disclosure provides various approaches for how the flow information is handled with compressed SIDs. FIG. 5 illustrates various formats 70, 72, 74, 76, 78 of compressed SIDs utilized in SRv6 technology, specifically highlighting two primary compressed SID categories: micro SIDs (uSID) and generic SIDs (GSID). The uSID formats 70, 72 depicted include compact structures with a shared prefix followed by multiple shorter, individual SIDs. Two distinct variations are shown:
(1) 32-bit Prefix uSID: This format 70 includes a common 32-bit prefix field, followed by up to six sequential 16-bit micro-SIDs labeled SID5 through SID0. The shared prefix defines a routing domain or network segment, while each compact 16-bit SID specifies individual node-level or segment-level routing instructions. The use of multiple smaller SIDs enables efficient packing and processing, significantly reducing header overhead and enhancing scalability.
(2) 48-bit Prefix uSID: Similarly, this format 72 utilizes a longer, 48-bit common prefix field, accommodating networks requiring more extensive addressing. It is followed by up to five 16-bit micro-SIDs (SID4 through SID0), still providing efficient routing instruction encoding while accommodating larger network architectures.

The GSID formats 74, 76, 78 shown offer greater flexibility with slightly larger identifiers, supporting more extensive or hierarchical addressing scenarios. Three variations of the GSID format are illustrated:
(1) 32-bit Prefix GSID: This format 74 contains a 32-bit common prefix, a 32-bit generic SID (GSID) for specifying individual segment instructions, a 62-bit padding field to ensure proper alignment, and a 2-bit Segment Identifier indicator (SI). The SI bits indicate the processing mode for the SID, ensuring correct handling by network nodes.
(2) 48-bit Prefix GSID: This GSID format 76 extends the common prefix length to 48 bits, which enables addressing in larger or more complex network domains. The GSID remains 32 bits, while padding is reduced to 46 bits, maintaining alignment. The standard 2-bit SI field is again included for consistent segment identification processing.
(3) 64-bit Prefix GSID: This largest GSID format 78 includes a 64-bit prefix field designed for highly expansive networks or hierarchical addressing schemes. The GSID itself remains at 32 bits, with padding further reduced to 30 bits. The 2-bit SI field completes the format, guiding nodes in processing the segment instructions appropriately.

Overall, these compressed SID formats (uSID and GSID) significantly optimize header size, reduce packet overhead, and enhance network scalability and processing efficiency. Each format provides different trade-offs concerning addressable scale, operational complexity, and flexibility, allowing network operators to select the SID structure best aligned with their specific network topology, scalability requirements, and operational needs.

As illustrated in FIG. 5, compressed SIDs lack the dedicated argument field that is present in uncompressed SID formats. Taking uSID as a specific example, each SID is structured with a shared common prefix of either 32 bits or 48 bits, followed by individual compact 16-bit SID values. This compressed structure is optimized for efficiency and scalability; however, it inherently presents a significant challenge: there is no predefined space or dedicated field available within these compressed SIDs to store essential per-flow information required for 5G MUP deployments, such as QFI and RQI. As a result, conventional methods defined for uncompressed SIDs—specifically utilizing the argument field to preserve QoS data—cannot be directly applied to compressed SID formats. This limitation poses a clear obstacle in deploying scalable, efficient SRv6 solutions capable of end-to-end QoS enforcement for 5G mobile networks.

### Utilizing the Compressed SID Common Prefix Field

Again, the present disclosure provides approaches to accommodate QoS flow information within compressed uSIDs. In an embodiment, a first approach uses the least significant 8 bits (LSB) of the common prefix field in uSID to store QFI and RQI bits derived from the GTP-U extension header. Additionally, one reserved or currently unused bit from the PDU extension header may be included in these 8 bits to provide potential future expansion capability.

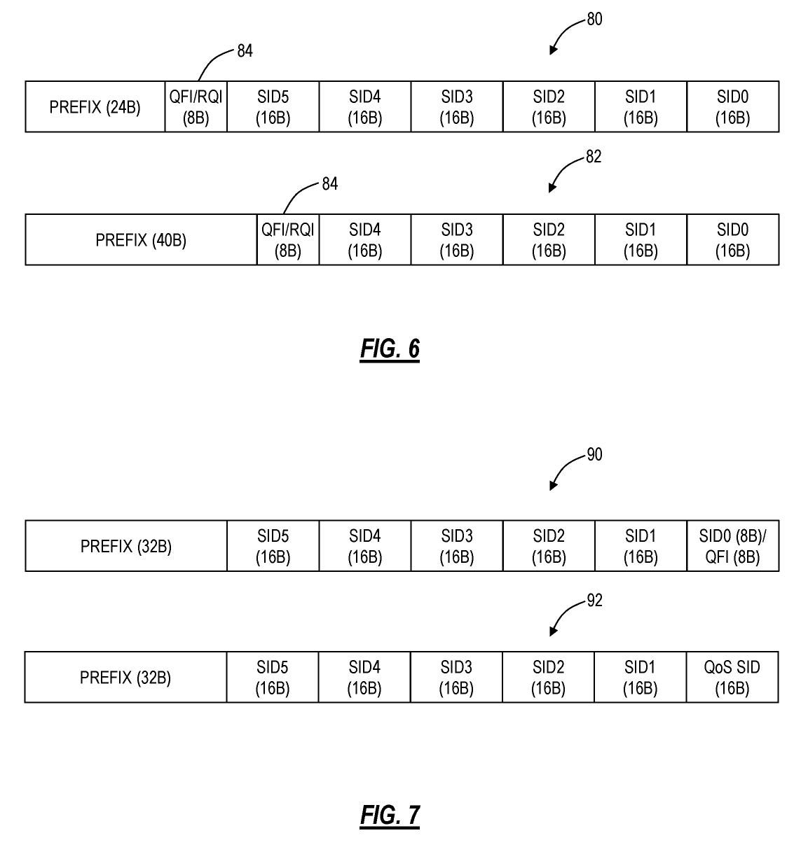

FIG. 6 illustrates two examples of modified uSID formats 80, 82 showing use of the common prefix field for QFI/RQI information 84. The uSID format 80 is a 32-bit prefix variant, where the original 32-bit prefix is reduced to 24 bits, reserving the last 8 bits explicitly for carrying the QFI/RQI information 84. This 8-bit QoS field is appended immediately following the shortened prefix and precedes the series of 16-bit SID fields (SID5 through SID0). The uSID 82 is a 48-bit prefix variant, where the same concept is applied, shortening the original 48-bit prefix to 40 bits and allocating the final 8 bits of the prefix field to store the QFI/RQI bits. Again, this QoS-specific field directly precedes the 16-bit SID segments (SID4 through SID0).

The introduced QFI/RQI information 84 represents a newly defined usage within the existing prefix field structure. Since the prefix field is shared across all SIDs within a single container, these QoS bits are consistently accessible to any SID in that group. However, in practical application, only the ingress SRGW 12 node—responsible for initially embedding the QoS information—and the egress (last endpoint) SRv6 node—responsible for interpreting and processing QoS data—require visibility into the QFI/RQI field. Intermediate nodes do not necessarily process or utilize this QoS-encoded information, thus maintaining network efficiency and scalability.

This approach ensures the compact yet effective integration of QoS flow information within compressed uSID structures. It provides a scalable and efficient solution for preserving QoS integrity end-to-end across SRv6-based mobile user-plane networks, specifically addressing the challenge posed by the absence of a dedicated argument field in compressed SID formats.

In the uplink direction, the configuration of the forwarding plane is governed by BGP MUP Network Layer Reachability Information (NLRI), based on 3GPP-5G type 1 routing, through which QFI information is communicated. The allocation of SIDs in the control plane leverages the received QFI information, embedding it directly into the SID structure, specifically setting the least significant 8 bits (LSB) of the common prefix field to match the QFI and RQI bits.

When uplink GTP-U packets from the mobile network arrive at the SRGW 12 through the gNodeB, packet processing begins with classification based on Virtual Routing and Forwarding (VRF), followed by IP tunnel termination using the End.M.GTP.D behavior within the UPF. During this termination process, with a standard GTP UDP port number of 2152, a Tunnel Endpoint Identifier (TEID), and a GTP-U extension header (type 133), the QFI/RQI bits are extracted and copied into the egress pipeline. Specifically, these bits may be placed into the reserved LSB 8 bits of the common prefix field of the last SID. The remaining header structure follows the standard SRH as defined by RFC standards, allowing the packet to traverse the IPv6/SRv6 network without additional modifications. Upon reaching the egress Provider Edge (PE), where the last SID is processed, the internal Remarked Class of Service (RCoS) value is derived directly from these LSB 8 bits of the common prefix. This value can then be used for DSCP remarking, ensuring accurate QoS enforcement in alignment with the specific endpoint processing behavior.

In the downlink direction, a similar but reverse SRH configured via the SRGW's SID prefix, again leveraging the LSB 8 bits to store the QFI information as conveyed through the NLRI. As downlink packets enter the SRGW from the IPv6/SRv6 network, the SRGW retrieves the QFI/RQI bits stored within these prefix bits and copies them into the GTP-U PDU extension header during the End.M.GTP.E encapsulation operation. Following this step, the packets are encapsulated into an IP tunnel, preserving the QoS flow information. This method ensures consistent QoS information propagation back into the mobile network, supporting precise end-to-end QoS management and optimized user experiences in 5G deployments.

Embedding QoS flow information into the common prefix field of compressed SIDs offers several advantages, notably simplicity and efficiency. By utilizing existing SID structures, this approach minimizes the complexity of packet processing, facilitating streamlined embedding and retrieval of QoS data without necessitating additional headers or dedicated fields. It significantly reduces packet overhead, thus preserving network throughput and efficiency. Furthermore, the method simplifies implementation and accelerates deployment, since it leverages fields already recognized by existing SRv6-capable nodes. This ensures transparent and consistent end-to-end QoS enforcement across network segments. However, there are notable disadvantages to consider. Shortening the common prefix to accommodate QoS information inherently limits addressing space, potentially constraining network scalability and the number of supported segments. Existing deployments may face compatibility and migration challenges, requiring careful network planning and reconfiguration. Additionally, the limited size available within the prefix restricts the granularity and future extensibility of QoS data. Finally, since the common prefix is shared among multiple SIDs, embedding QoS information directly impacts SID management, necessitating meticulous allocation strategies to prevent operational complexities and unintended interactions across the network.

As set forth above, a common prefix field may be used to carry both the conventional common prefix information and the QoS information. By some devices, and for some purposes, this common prefix field may be treated as a single field. In some embodiments, at least some devices may treat the common prefix field as two separate fields, i.e. a common prefix field (which is shortened so as to make room for a new QoS information field) and the QoS information field.

### Repurposing the SID0 Field in uSID

In another embodiment, a second approach leverages specific portions of the SID fields within the compressed uSID format to store QFI and RQI bits extracted from the GTP-U extension header. This embodiment presents several approaches for supporting end-to-end QoS flow enforcement in 5G SRv6 deployments. The first approach involves partitioning at least one existing 16-bit SID field (e.g., that of SID0) into two distinct segments: a (e.g. 8-bit) segment for the original SID value and another (e.g. 8-bit) segment dedicated explicitly to QoS flow information. This approach enables the embedding of QFI and RQI data directly within a SID field, providing a straightforward means for network nodes to retrieve QoS information without requiring additional packet fields or encapsulation.

The second approach proposes assigning a dedicated SID for each individual QoS flow, where the SID value itself serves as a direct mapping from the GTP-U extension QoS parameters. In this scenario, each QoS flow would have a unique SID assigned explicitly to represent its QoS characteristics, simplifying traffic classification and processing. This dedicated SID approach can provide clear, unambiguous QoS enforcement along the entire forwarding path within the SRv6 network, ensuring consistent handling of individual flows. Both approaches offer efficient mechanisms to carry QoS information within compressed SIDs, addressing the inherent limitations posed by the absence of an argument field in compressed SID formats. These solutions enhance scalability and operational simplicity, enabling precise and effective end-to-end QoS enforcement for next-generation 5G networks employing SRv6 technology.

FIG. 7 illustrates two alternative embodiments for embedding QoS flow information within uSID formats 90, 92 to facilitate end-to-end QoS enforcement in 5G networks employing SRv6. With the format 90, the standard 16-bit SID0 field within the uSID structure is explicitly partitioned into two 8-bit segments. The first 8 bits remain dedicated to the original SID0 value, representing node-level routing instructions or segment identifiers. The remaining 8 bits are specifically allocated to store QFI and RQI bits extracted from the GTP-U extension header. Additionally, a currently unused 1-bit field from the PDU extension header is included alongside the QFI/RQI bits, preserving flexibility and allowing future expansion or enhancements in QoS management without restructuring the packet format.

The format 92 depicted in FIG. 7 provides an alternative approach, in which the entire 16-bit SID0 field is repurposed as a dedicated "QoS SID." In this scenario, each unique QoS flow is represented explicitly by a distinct SID value assigned directly from the QoS parameters conveyed through the GTP-U extension header. This dedicated QoS SID facilitates straightforward, explicit mapping and enforcement of QoS characteristics along the forwarding path in the SRv6 network, ensuring clear visibility and simplified processing of per-flow QoS requirements.

Both approaches effectively embed QoS information within compressed SID formats, circumventing the inherent limitations posed by the absence of an argument field in compressed SIDs. By leveraging either of these approaches, network operators can efficiently maintain end-to-end QoS flow integrity, enhancing network scalability, operational simplicity, and ensuring a high-quality user experience within SRv6-based 5G mobile user plane deployments.

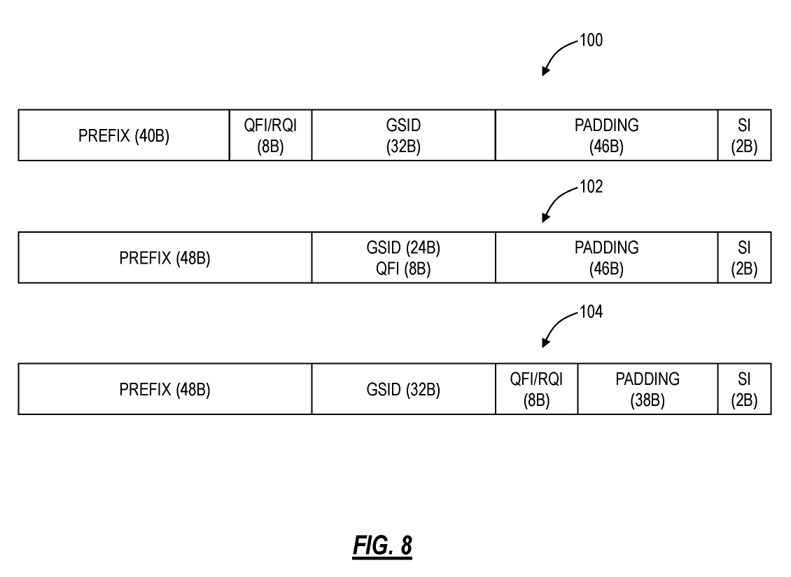

FIG. 8 illustrates alternative embodiments of embedding QoS flow information within compressed Generic Segment Identifiers (GSIDs), extending the approaches previously discussed for uSIDs. Unlike uSIDs, each GSID occupies a complete 128-bit container, offering flexibility through an associated padding field that can be repurposed to store QoS information. FIG. 8 depicts three distinct GSID formats 100, 102, 104 for integrating QoS Flow Identifier (QFI) and Reflective QoS Indication (RQI) bits.

In the format 100, the common prefix field is shortened to 40 bits, with the subsequent 8bits explicitly reserved for QFI/RQI information. The original GSID field of 32 bits is preserved, followed by 46 bits of padding and a standard 2-bit SI indicator. By embedding QoS bits directly after the prefix, this method enables straightforward extraction and processing of QoS information without altering the GSID itself.

The format 102 maintains a standard 48-bit prefix field and divides the subsequent 32-bit GSID field into two segments: a 24-bit GSID value and an 8-bit QFI/RQI field. The remaining fields consist of a 46-bit padding and the usual 2-bit SI indicator. This approach efficiently incorporates QoS information within the GSID field, reducing the complexity of packet parsing and ensuring QoS data visibility for endpoint processing. If the GSID field is considered to be a SID value field of the compressed SID, then the format 102 can be implemented by embedding the QoS flow information directly into such a SID value field.

In the format 104, the original 48-bit prefix and full 32-bit GSID fields remain unchanged, but the QFI/RQI bits are placed (e.g., immediately) after the GSID field, consuming 8 bits of the original padding area. The remaining padding is reduced to 38 bits, followed by the standard 2-bit SI indicator. This embodiment preserves the full integrity of both prefix and GSID fields while effectively utilizing the existing padding space to store QoS flow information. In such embodiments, the extracted QoS flow information is embedded into a compressed SID, and in particular is embedded directly into a padding field of such a compressed SID (e.g. GSID), e.g. at a designated location in the padding field, such as the 8 MSB in the illustrated format 104.

These GSID-based approaches allow network operators to flexibly embed QoS information within existing SID containers, addressing the absence of a dedicated argument field and ensuring consistent end-to-end QoS enforcement. By repurposing (portions of) the prefix, padding and/or SID fields strategically, the proposed methods enhance scalability, efficiency, and operational simplicity in SRv6-based 5G mobile user-plane deployments.

In the uplink direction, the configuration of the forwarding plane is guided by the BGP MUP NLRI, specifically based on 3GPP-5G type 1 routes, which communicate QFI information. Depending on the selected method, the SIDs are handled differently. In the first approach described previously, SIDs are allocated in the control plane using QFI information, explicitly embedding the last 8 bits with the QFI and RQI bits derived from the GTP-U extension header. Conversely, the second approach defined above does not directly copy QoS flow information into the SID. Instead, each distinct QoS flow is mapped to a dedicated SID in the SRv6 encapsulation service tunnel, clearly associating specific QoS flows with specific SIDs at the control-plane level.

Operationally, when uplink GTP-U packets arrive at the SRGW 12 from the mobile site through the gNodeB, these packets are first classified based on VRF contexts, followed by IP tunnel termination employing the End.M.GTP.D function within the User Plane Function (UPF). During this termination phase, packets are recognized using standard GTP parameters such as UDP destination port 2152, TEID, and GTP extension header type 133. Upon recognition, the QFI/RQI bits from the GTP extension header are copied into the egress pipeline. Specifically, in the first approach, these bits are embedded directly into the least significant 8 bits of the last SID value field. Apart from this QoS embedding step, the remaining packet headers follow the standard SRH format as defined by relevant RFCs, allowing normal traversal across the IPv6/SRv6 network without special handling by intermediate nodes.

At the egress PE node, upon processing the last SID during the function termination phase, an internal RCoS value is derived directly from the embedded QoS bits in the SID. This RCoS value can then be applied to DSCP remarking, ensuring accurate QoS enforcement aligned with defined endpoint behaviors.

In the downlink direction, traffic handling follows a similar but reversed procedure. With the first approach, downlink SRv6 packet encapsulation similarly uses 8 bits within the SID value field, determined by the BGP NLRI QFI value. In the second method, QoS flow information is represented by allocating a distinct 16-bit SID for each QoS flow, directly mapped and assigned based on control-plane BGP messaging.

When downlink SRv6 packets arrive at the SRGW from the IPv6/SRv6 network, the embedded QoS flow information (QFI/RQI) is extracted and then explicitly copied into the GTP-U Protocol Data Unit (PDU) extension header as part of the End.M.GTP.E encapsulation process performed by the UPF function. Subsequently, the packets undergo IP tunnel encapsulation toward the mobile network infrastructure. This ensures that critical QoS flow information is consistently and accurately communicated back to the mobile network components such as gNodeBs, maintaining the integrity of QoS enforcement throughout the complete network path in support of high-quality 5G service deployments.

### Comparison

In contrast to the prefix-based approach, this second approach involves no modification to the common prefix field, which remains shared among all Segment Identifiers (SIDs). Instead, this second approach repurposes portions of the last SID after the prefix to embed QoS flow information directly. Traditionally, the locator and function components of the last SID are co-located within a single SID container, processed at the egress SRv6 node or the final endpoint node. This approach retains that structure, but instead of using the 16-bit SID function field exclusively to represent network services or forwarding behaviors, the method explicitly associates this 16-bit SID value with QoS flow information for specific service flows. Consequently, the QoS-encoded SID becomes directly associated with a defined QoS flow within the service context. Importantly, this embedded QoS information is only interpreted and processed at two critical SRv6 nodes—the ingress SRGW 12 and the egress endpoint—thus minimizing processing complexity at intermediate nodes.

This second approach has several notable advantages. By preserving the original prefix field intact, it maintains complete scalability and addressing capacity, ensuring compatibility with existing SID allocation and routing practices. Furthermore, it simplifies integration and deployment, reducing potential operational complexity associated with modifying existing prefix structures. Explicitly associating QoS flows with dedicated SIDs or SID segments also enables precise and straightforward QoS enforcement, significantly simplifying packet classification at ingress and egress points. Additionally, QoS flow SIDs in this approach can be shared among different node SIDs because they are allocated per QoS flow as dedicated SID functions, enhancing SID utilization efficiency and reducing overall resource consumption.

However, this approach also presents certain disadvantages. Primarily, embedding QoS flow data directly within SID fields can limit the number of available bits for traditional locator or function identification, potentially constraining the total number of unique network functions or services represented by each SID. This could increase the complexity of SID allocation and management, requiring meticulous planning to avoid conflicts and maintain operational clarity. Additionally, as QoS data is visible only to ingress and egress nodes, intermediate nodes have limited visibility, potentially complicating troubleshooting and operational diagnostics related to QoS flows.

Both approaches effectively support end-to-end QoS flows within 5G MUP networks. However, their implications for UPF tunnel scalability and forwarding-plane operations differ significantly between the SRGW 12 and the egress endpoint nodes. Specifically, the first approach, which embeds QoS information in the shared prefix field, leads to a multiplication of the number of QoS flows across all SID containers, resulting in greater consumption of hardware resources and scale. In contrast, the second approach allocates QoS flow information within SID functions, enabling more efficient SID reuse across multiple nodes, thereby significantly conserving hardware resources and enhancing overall operational scalability.

Each uncompressed SID occupies a full 128 bits within a SID container. In contrast, the uSID format currently supported allows for packing up to six compressed SIDs into a single 128-bit container. Consequently, the use of compressed SIDs significantly reduces packet overhead compared to uncompressed SID formats. Given that Segment Routing is fundamentally a source-based routing technology, adopting compressed SIDs enhances network efficiency by providing up to six times greater SID depth for detailed path specification. Additionally, because compressed SIDs consume less hardware memory per UPF, network operators can achieve higher scalability, accommodating a substantially greater number of tunnels with a reduced memory footprint.

Overall, this disclosure effectively supports end-to-end QoS enforcement within 5G MUP networks employing SRv6 technology with compressed SIDs. The QoS enforcement mechanisms described are specifically implemented at the ingress SRGW and the egress PE nodes. Crucially, these methods remain fully compliant with existing standards, ensuring seamless integration into current network infrastructures. By enabling new deployments leveraging compressed SID formats, this approach provides significant benefits, including reduced packet overhead, deeper SID stack support, increased tunnel scalability, and more efficient memory utilization.

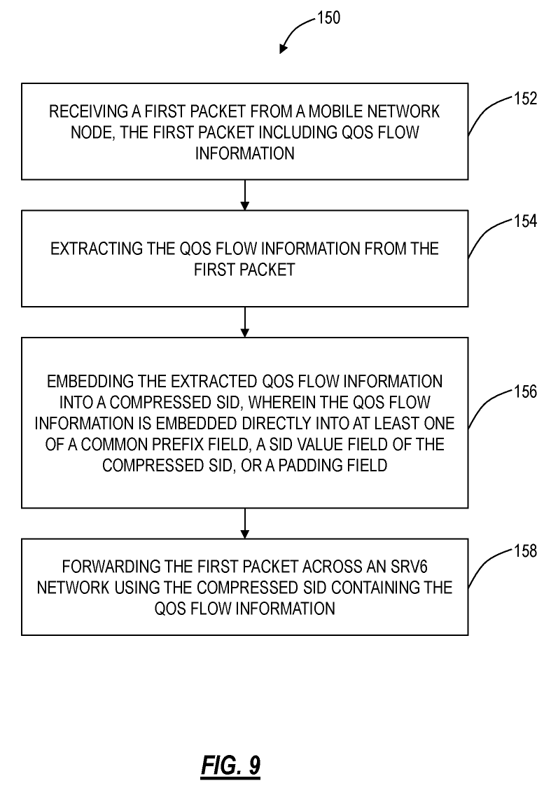

FIG. 9 illustrates a flowchart of a process 150, performed by a Segment Routing Gateway (SRGW), for supporting Quality of Service (QoS) flows in a Segment Routing over IPv6 (SRv6) mobile user plane (MUP) network using compressed Segment Identifiers (SIDs). The process 150 contemplates implementation as a method with steps, via circuitry configured to implement the steps, and as a non-transitory computer-readable medium storing instructions that, when executed, cause circuitry to implement the steps.

The steps include receiving a first packet from a mobile network node, the first packet including QoS flow information (step 152); extracting the QoS flow information from the first packet (step 154); embedding the extracted QoS flow information into a compressed SID, wherein the QoS flow information is embedded directly into at least one of a common prefix field, a SID value field of the compressed SID, or a padding field (step 156); and forwarding the first packet across an SRv6 network using the compressed SID containing the QoS flow information (step 158). The steps can further include receiving, at the SRGW, a second packet from the SRv6 network, the second packet containing the compressed SID with embedded QoS flow information; retrieving the QoS flow information from the compressed SID in the second packet; and re-embedding the QoS flow information into an encapsulation header of the second packet for forwarding toward the mobile network node.

The first packet can include a General Packet Radio Service (GPRS) Tunneling Protocol User Plane (GTP-U) packet, and wherein the QoS flow information is embedded within a GTP-U extension header. The extracting QoS flow information can include extracting a QoS Flow Identifier (QFI) and a Reflective QoS Indication (RQI) from the GTP-U extension header. The embedding QoS flow information into the compressed SID can include repurposing a portion of a common prefix field of a micro-SID (uSID), or a GSID prefix field. The portion of the common prefix field can include least significant 8 bits of the common prefix field. The steps can further include including within the 8 bits at least one reserved bit from the received first packet header to support future QoS expansion.

The embedding QoS flow information into the compressed SID can include partitioning a 16-bit SID value field of a micro-SID (uSID) into a first portion representing a SID value and a second portion representing the QoS flow information. The first portion can include 8 bits and the second portion can include 8 bits including a QoS Flow Identifier (QFI) and a Reflective QoS Indication (RQI). The embedding QoS flow information into the compressed SID can include assigning an entire SID value field of a micro-SID (uSID) as a dedicated QoS SID uniquely representing QoS flow parameters. The QoS SID can be allocated per QoS flow and is shared among multiple node-specific SIDs, thereby reducing hardware resource consumption and increasing tunnel scalability. The embedding QoS flow information into the compressed SID can include embedding the information into a portion of a GSID field.

The embedding QoS flow information can include utilizing padding bits within a 128-bit generic SID (GSID) container to store QoS flow information. The GSID can include a 32-bit prefix and a 32-bit SID value, and the QoS flow information is stored in padding bits immediately following the SID value. As already mentioned above, the GSID can include a prefix field shortened to accommodate 8 bits dedicated to QoS flow information, and the QoS flow information may immediately follow the shortened prefix field. The steps can include configuring the compressed SID embedding QoS flow information based on control-plane signaling received through Border Gateway Protocol (BGP) 3GPP 5G Network Layer Reachability Information (NLRI). The SRGW and an egress node are the only network nodes configured to interpret and process the embedded QoS flow information, with intermediate SRv6 nodes remaining transparent to the QoS flow information.

### Router

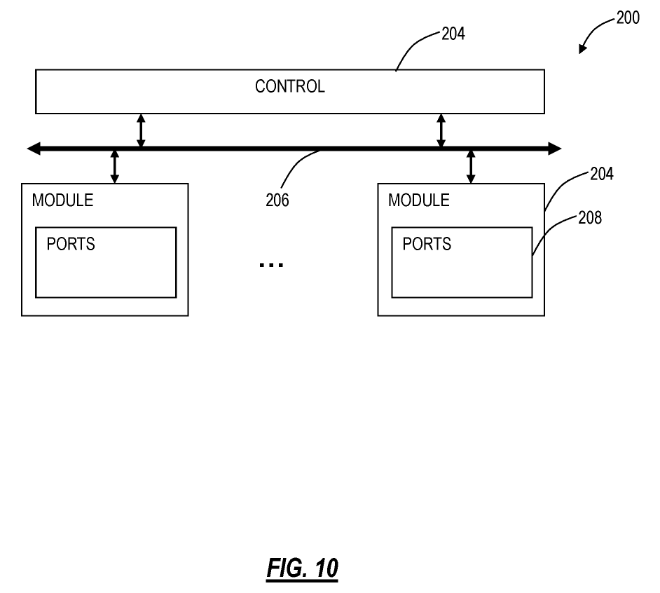

FIG. 10 illustrates a block diagram of a router 200, depicted in a simplified functional format. It is important to note that a more practical design of this router would likely include additional components and processing logic to accommodate standard operating features, which are not detailed here. The router 200 may represent any network element operable in the network 10, and includes various interconnected modules, such as modules 204, 204, via an interface 206, such as a backplane, midplane, cabling, etc. These modules, also known as blades or line cards, are typically mounted on the chassis. Each module 204, 206 can house numerous electronic or optical devices on a circuit board, complete with various interconnects, including interfaces to the chassis itself.

Specifically, the diagram illustrates two types of modules: line modules 200, which feature multiple ports 208 for external connections, and a control module 204. The line modules 202 facilitate data traffic switching between ports 208 via a switching fabric, which can be integrated across the modules 202, potentially centralized in a separate unit or module (not shown), as well as a combination. This switching fabric includes hardware, software, and firmware that routes data between the ports 208. The control module 204 is equipped with processing circuity, memory, software, and a network interface to manage operations such as configuration and monitoring of the router 200. It may also communicate with external network management systems or databases that handle provisioning and operational data.

Lastly, while FIG. 10 provides a basic view, those skilled in the art will understand that the router 200 could include additional components or be configured differently, such as in a distributed arrangement or as an integrated, rack-mounted unit (often referred to as a "pizza-box" configuration). This depiction in FIG. 10 is intended to convey functional aspects, with actual hardware implementations varying widely. In an embodiment, the router 200 can be any of the network elements described herein, including the SRGW 12 and the like.

Further, those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits "configured to" or "adapted to" execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of,” when referring to a list of items, encompass any combination of those items, including any single item. For example, the expressions “at least one of A, B, or C,” “at least one of A, B, and C,” “one or more of A, B, or C,” and “one or more of A, B, and C” cover the possibilities of only A, only B, only C, any combination of A and B, A and C, B and C, or all three (A, B, and C). This also includes scenarios involving more or fewer elements than A, B, and C. Additionally, the terms “comprise,” “comprises,” “comprising,” “include,” “includes,” and “including” are intended to be open-ended and non-limiting, specifying essential elements or steps without excluding additional elements or steps—even where a claim or multiple claims contain more than one such term.

It should be understood that the drawings, descriptions, and examples provided herein merely illustrate various aspects and embodiments of the disclosure. Numerous modifications, changes, or arrangements may be made without departing from the spirit and scope of the disclosure. Although certain steps, operations, instructions, blocks, or similar elements (collectively referred to as “steps”) are depicted or described in a specific order, such ordering is not necessarily required unless explicitly stated. Nor does it imply that all depicted steps are essential to achieve the desired results. Extra steps may be performed before, after, concurrently, or interspersed with the illustrated or described steps. Multitasking, parallel processing, and other types of concurrent execution are also contemplated. Further, the separation of system components or steps described should not be interpreted as mandatory in all implementations; such components, steps, or elements may be integrated into a single configuration or distributed across multiple ones.

While this disclosure has been shown and described through specific embodiments and examples, those skilled in the art will recognize that many variations and modifications can provide equivalent functionality or yield comparable results. Such alternative embodiments and variations, even if not explicitly mentioned here, fall within the spirit and scope of this disclosure if they achieve the stated objectives and adhere to the underlying principles. Accordingly, they are envisioned and encompassed by the disclosure and protected by the associated claims. In other words, the present disclosure anticipates combinations and permutations of the described elements, operations, steps, methods, processes, algorithms, functions, techniques, modules, and circuits in any feasible sequence or arrangement—whether collectively, separately, or in subsets—thereby broadening the range of potential embodiments.

What is claimed is:

1. A method implemented by a Segment Routing Gateway (SRGW) for supporting Quality of Service (QoS) flows in a Segment Routing over IPv6 (SRv6) mobile user plane (MUP) network using compressed Segment Identifiers (SIDs), comprising:
receiving a first packet from a mobile network node, the first packet including QoS flow information;
extracting the QoS flow information from the first packet;
embedding the extracted QoS flow information into a compressed SID, wherein the QoS flow information is embedded directly into at least one of a common prefix field, a SID value field of the compressed SID, or a padding field; and
forwarding the first packet across an SRv6 network using the compressed SID containing the QoS flow information.

2. The method of claim 1, further comprising
receiving, at the SRGW, a second packet from the SRv6 network, the second packet containing the compressed SID with embedded QoS flow information;
retrieving the QoS flow information from the compressed SID in the second packet; and
re-embedding the QoS flow information into an encapsulation header of the second packet for forwarding toward the mobile network node.

3. The method of claim 1, wherein the first packet includes a General Packet Radio Service (GPRS) Tunneling Protocol User Plane (GTP-U) packet, and wherein the QoS flow information is embedded within a GTP-U extension header.

4. The method of claim 3, wherein the extracting QoS flow information includes extracting a QoS Flow Identifier (QFI) and a Reflective QoS Indication (RQI) from the GTP-U extension header.

5. The method of claim 1, wherein the embedding QoS flow information into the compressed SID includes repurposing a portion of a common prefix field of a micro-SID (uSID).

6. The method of claim 5, wherein the portion of the common prefix field includes least significant 8 bits of the common prefix field.

7. The method of claim 6, further comprising
including within the 8 bits at least one reserved bit from the first packet header to support future QoS expansion.

8. The method of claim 1, wherein the embedding QoS flow information into the compressed SID includes partitioning a 16-bit SID value field of a micro-SID (uSID) into a first portion representing a SID value and a second portion representing the QoS flow information.

9. The method of claim 8, wherein the first portion includes 8 bits and the second portion includes 8 bits including a QoS Flow Identifier (QFI) and a Reflective QoS Indication (RQI).

10. The method of claim 1, wherein the embedding QoS flow information into the compressed SID includes assigning an entire SID value field of a micro-SID (uSID) as a dedicated QoS SID uniquely representing QoS flow parameters.

11. The method of claim 10, wherein the QoS SID is allocated per QoS flow and is shared among multiple node-specific SIDs, thereby reducing hardware resource consumption and increasing tunnel scalability.

12. The method of claim 1, wherein the embedding QoS flow information includes utilizing padding bits within a 128-bit generic SID (GSID) container to store QoS flow information.

13. The method of claim 12, wherein the GSID includes a 32-bit prefix and a 32-bit SID value, and the QoS flow information is stored in padding bits immediately following the SID value.

14. The method of claim 1, wherein, subsequent to the forwarding, the dedicated QoS SID is processed directly as a SID by network nodes, facilitating explicit QoS handling.

15. The method of claim 1, further comprising
configuring the compressed SID embedded QoS flow information based on control-plane signaling received through Border Gateway Protocol (BGP) 3GPP 5G Network Layer Reachability Information (NLRI).

16. The method of claim 1, wherein the SRGW and an egress node are only network nodes configured to interpret and process the embedded QoS flow information, with intermediate SRv6 nodes remaining transparent to the QoS flow information.

17. A Segment Routing Gateway (SRGW) configured to support Quality of Service (QoS) flows in a Segment Routing over IPv6 (SRv6) mobile user plane (MUP) network using compressed Segment Identifiers (SIDs), the SRGW comprising circuitry configured to:
receive a first packet from a mobile network node, the first packet including QoS flow information;
extract the QoS flow information from the first packet;
embed the extracted QoS flow information into a compressed SID, wherein the QoS flow information is embedded directly into at least one of a common prefix field, a SID value field of the compressed SID, or a padding field; and
forward the first packet across an SRv6 network using the compressed SID containing the QoS flow information.

18. The SRGW of claim 17, wherein the circuitry is further configured to
receive a second packet from the SRv6 network, the second packet containing the compressed SID with embedded QoS flow information;
retrieve the QoS flow information from the compressed SID in the second packet; and
re-embed the QoS flow information into an encapsulation header of the second packet for forwarding toward the mobile network node.

19. The SRGW of claim 17, wherein the first packet includes a General Packet Radio Service (GPRS) Tunneling Protocol User Plane (GTP-U) packet, and wherein the QoS flow information is embedded within a GTP-U extension header.

20. A non-transitory computer-readable medium storing instructions that, when implemented by a Segment Routing Gateway (SRGW) for supporting Quality of Service (QoS) flows in a Segment Routing over IPv6 (SRv6) mobile user plane (MUP) network using compressed Segment Identifiers (SIDs), cause the SRGW to perform steps of:
receiving a first packet from a mobile network node, the first packet including QoS flow information;
extracting the QoS flow information from the first packet;
embedding the extracted QoS flow information into a compressed SID, wherein the QoS flow information is embedded directly into at least one of a common prefix field, a SID value field of the compressed SID, or a padding field; and
forwarding the first packet across an SRv6 network using the compressed SID containing the QoS flow information.
